(19) United States
(12) Patent Application Publication
(10) Pub. No.: US 2020/0026412 A1
(43) Pub. Date: Jan. 23, 2020

(54) SCREEN FINGERPRINT ENABLEMENT SYSTEM OF ELECTRONIC DEVICE

(71) Applicant: Chiun Mai Communication Systems, Inc., New Taipei (TW)

(72) Inventor: YU-CHUN CHEN, New Taipei (TW)

(21) Appl. No.: 16/516,345

(22) Filed: Jul. 19, 2019

(30) Foreign Application Priority Data
Jul. 19, 2018 (CN) 201810795530.8

(51) Int. Cl. G06F 3/0481; G06F 3/0488; G06F 3/0482; G06K 9/00

(52) U.S. Cl. CPC G06F 3/04817; G06K 9/00006; G06F 3/0482; G06F 3/04883

(57) ABSTRACT

A screen fingerprint enablement method implemented in an electronic device including a touch sensor and a fingerprint sensor includes displaying an user interface and a fingerprint icon simultaneously on a display of the electronic device, detecting an input signal on the display by using the touch sensor, responding to the fingerprint event corresponding to the input signal when the input signal is applied within the area corresponding to the fingerprint sensor, and responding to the touch event corresponding to the input signal when the input signal is not applied within the area corresponding to the fingerprint sensor. The fingerprint icon is displayed in an area corresponding to the fingerprint sensor. A corresponding touch event and a corresponding fingerprint event are generated according to the input signal detected by the touch sensor and the fingerprint sensor.

### FIELD

The subject matter herein generally relates to electronic devices, and more particularly to an electronic device implementing a screen fingerprint enablement method.

### BACKGROUND

Generally, full screen display screens of electronic devices that include fingerprint sensors arrange the fingerprint sensor under the display screen. In this way, the fingerprint sensor may interfere with normal operations of the display screen.

### BRIEF DESCRIPTION OF THE DRAWINGS

Implementations of the present disclosure will now be described, by way of embodiments, with reference to the attached figures.

FIG. 1 is a block diagram of an electronic device including a screen fingerprint enablement system.

FIG. 2 is a block diagram of function modules of the screen fingerprint enablement system of FIG. 1.

FIG. 3 is a flowchart of a first embodiment of a screen fingerprint enablement method.

FIG. 4 is a flowchart of a second embodiment of a screen fingerprint enablement method.

FIG. 5A is a diagram of a display and an area of the display corresponding to a fingerprint sensor.

FIG. 5B. is a diagram of the display displaying a fingerprint icon on the area.

FIG. 5C is a diagram of an user interface overlapped with the fingerprint icon.

FIG. 5D is a diagram of the user interface of FIG. 5C and the fingerprint icon displayed in a hidden area of the user interface.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

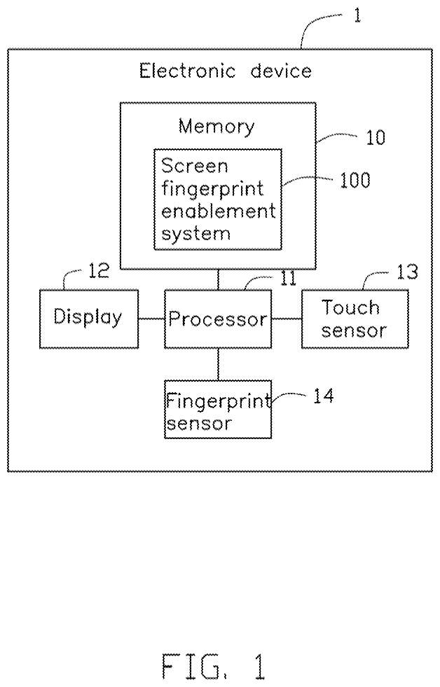

FIG. 1 shows an embodiment of an electronic device 1. The electronic device 1 may be a game console, a mobile phone, a tablet computer, or the like. The electronic device 1 includes, but is not limited to, a memory 10, a processor 11, a display 12, a touch sensor 13, and a fingerprint sensor 14.

The display 12 is a display screen of the electronic device 1. The display 12 may be a touch screen. The touch sensor 13 detects touch signals on the display screen 12.

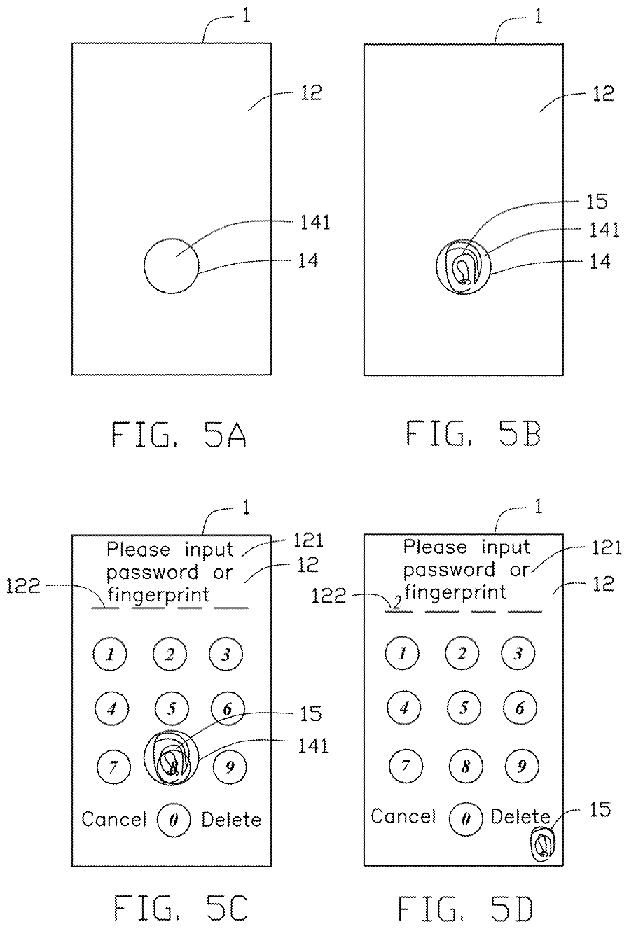

The fingerprint sensor 14 is mounted under the display 12 and detects a fingerprint. In one embodiment, as shown in FIG. 5A, an area of the display 12 where the fingerprint sensor 14 detects the fingerprint is an area 141 shown in FIG. 5A-5C.

The memory stores a screen fingerprint enablement system 100. The memory 10 may include, but is not limited to, a read-only memory, a random access memory, a programmable read-only memory, an erasable programmable read-only memory, a one-time programmable read-only memory, an electrically-erasable programmable read-only memory, an electrically-erasable programmable read-only memory, a compact disc read-only memory, or other optical storage disk, magnetic storage disc, or magnetic storage tape.

The processor 11 may be a central processing unit, a microprocessing unit, a graphics processing unit, or other data processing chip. The processor 11 executes functions of the screen fingerprint enablement system 100.

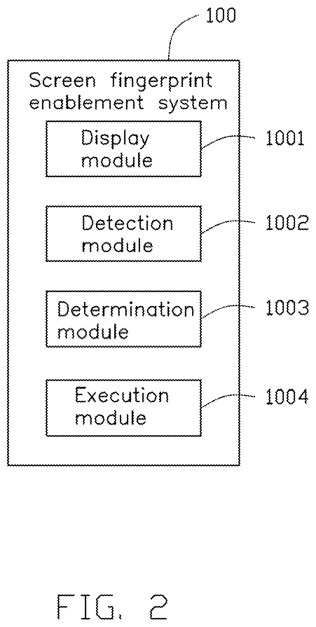

In one embodiment, the screen fingerprint enablement system 100 includes a plurality of modules. As shown in FIG. 2, the screen fingerprint enablement system 100 includes a display module 1001, a detection module 1002, a determination module 1003, and an execution module 1004.

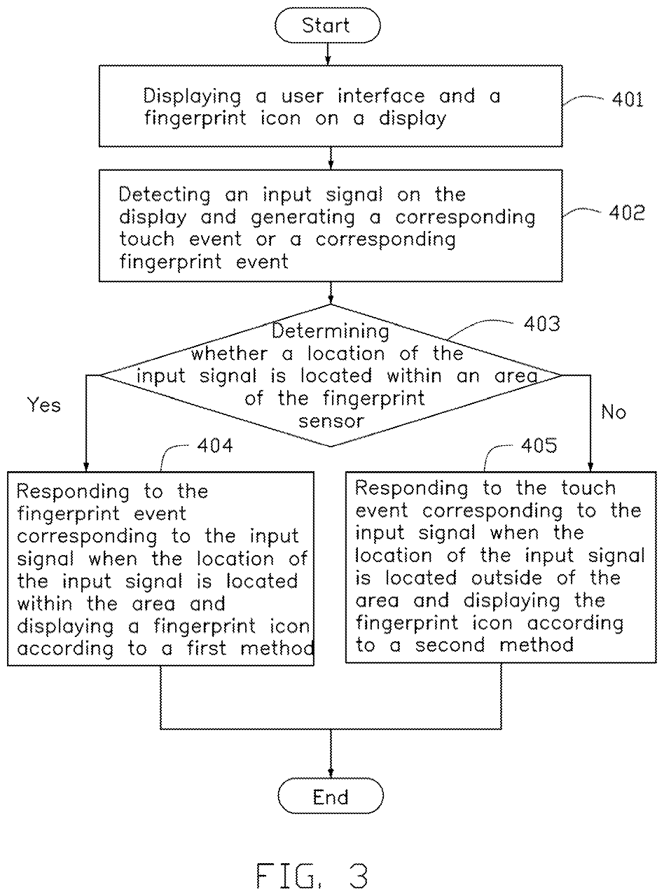

FIG. 3 illustrates a flowchart of a first embodiment of a screen fingerprint enablement method implemented in the electronic device 1. The method is provided by way of embodiments, as there are a variety of ways to carry out the method. The method described below can be carried out using the configurations illustrated in FIGS. 1-2 and 5, for example, and various elements of these figures are referenced in explaining the embodiment. Each block shown in FIG. 3 represents one or more processes, methods, or subroutines carried out in the embodiment. Furthermore, the illustrated order of blocks is by example only, and the order of the blocks can be changed. Additional blocks can be added or fewer blocks can be utilized, without departing from this disclosure. The method can begin at block S401.

At block S401, the display module 1001 displays an user interface 121 (shown in FIG. 5C) and a fingerprint icon 15 (shown in FIG. 5B) on the display 12. In one embodiment, the user interface 121 is an user verification interface.

In one embodiment, the display module 1001 displays the fingerprint icon 15 (shown in FIG. 5B) within the area 141 detected by the fingerprint sensor 14. The area 141 is an area of the display 12 where the fingerprint sensor 14 is capable of detecting a fingerprint.

In one embodiment, the fingerprint icon 15 may be a jpg image or a png image.

In one embodiment, the display module 1001 displays the fingerprint icon 15 overlapping the user interface 121.

In one embodiment the display module 1001 displays the fingerprint icon 15 according to a first method wherein the fingerprint icon 15 covers the user interface 121. For example, the display module 1001 displays the fingerprint icon 15 non-transparently on the area 141.

As shown in FIG. 5C, the user interface 121 is an user verification interface. The user interface 121 is overlapped with the fingerprint icon 15. The fingerprint icon 15 is displayed non-transparently on the area 141 so that the fingerprint icon 15 covers the number “8” of the user interface 121.

At block S402, the detection module 1002 uses the touch sensor 13 to detect an input signal on the display 12. When the detection module 1002 detects an input signal, the detection module 1002 generates a corresponding touch event. The detection module 1002 uses the fingerprint sensor 14 to detect an input signal on the display 12. When the detection module 1002 detects an input signal, the detection module 1002 generates a fingerprint event.

In one embodiment, the detection module 1002 uses the touch sensor 13 and the fingerprint sensor 14 to periodically detect in real time (such as every 0.2 milliseconds) the input signal on the display 12.

In one embodiment, the input signal is either a single touch signal or a pressing touch signal.

When a location of the input signal is located outside of the area 141 of the fingerprint sensor 14, the fingerprint sensor 14 is not able to detect the input signal, and the fingerprint event is not generated. When the location of the input signal is located within the area 141 of the fingerprint sensor 14, the fingerprint sensor is able to detect the input signal and generate the fingerprint event.

When the location of the input signal is located within the area 141 of the fingerprint sensor 14, since the touch sensor 13 and the fingerprint sensor 14 both detect the input signal, the detection module 1002 simultaneously generates a touch event and the fingerprint event.

At block S403, the determination module 1003 determines whether the location of the input signal is located within the area 141 of the fingerprint sensor 14. When the location of the input signal is located within the area 141, block S404 is implemented. When the input signal is located outside of the area 141, block S405 is implemented.

At block S404, when the location of the input signal is located within the area 141, the execution module 1004 responds to the fingerprint event corresponding to the input signal and does not respond to the touch event. In one embodiment, the display module 1001 displays the fingerprint icon 15 according to the first method.

The embodiment as shown in FIG. 5C, if the area 141 is pressed, the detection module 1002 uses the touch sensor 13 to detect the input signal and generate the touch event and also uses the fingerprint sensor 14 to detect the input signal and generate the fingerprint event. Because the location of the input signal is located within the area 141, the execution module 1004 only responds to the fingerprint event and does not respond to the touch event. For example, the execution module 1004 reads the fingerprint detected by the fingerprint sensor 14 and determines whether the fingerprint matches a prestored fingerprint. If the fingerprint matches the prestored fingerprint, the display 12 displays another user interface.

At block S405, when the location of the input signal is located outside of the area 141, the execution module 1004 responds to the touch event corresponding to the input signal. In one embodiment, the display module 1001 displays the fingerprint icon 15 according to a second method.

In one embodiment, the second method refers to the fingerprint icon 15 not covering the user interface 121. For example, the fingerprint icon 15 is displayed in another location (herein referred to as “the hidden area”) located outside of the area 141 and not covering the user interface 121. In another embodiment, the fingerprint icon 15 is displayed in the hidden location in a reduced size. In another embodiment, the fingerprint icon 15 is displayed translucently on the area 141 so that the fingerprint icon 15 does not cover the user interface 121.

The embodiment as shown in FIG. 5D, when a pressing touch is not applied within the area 141, such as pressing the number “2” on the user interface 121, the detection module 1002 uses the touch sensor 13 to detect the input signal and generate the touch event (pressing the number “2”). Since the location of the input signal is located outside of the area 141, the execution module 1004 responds to the touch event corresponding to the input signal. For example, the execution module 1004 can input the number “2” in a number input field 122 of the user interface 121. The display module 1001 simultaneously moves the fingerprint icon 14 from the area 141 to the hidden area (such as the lower right corner) and reduces a size of the fingerprint icon 15 by 10%.

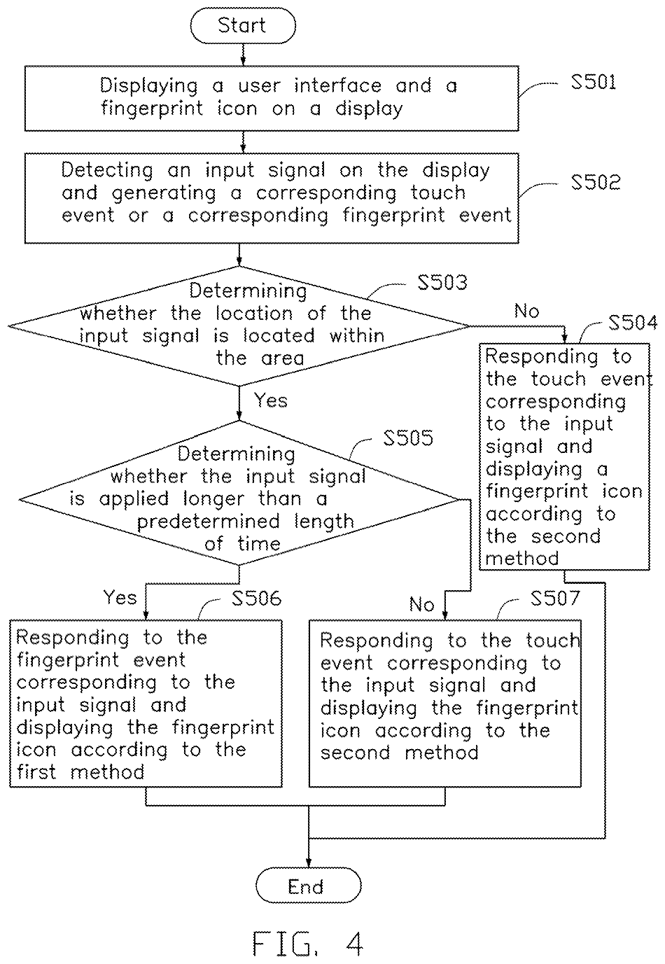

FIG. 4 illustrates a flowchart of a second embodiment of a screen fingerprint enablement method implemented in the electronic device 1. The method is provided by way of embodiments, as there are a variety of ways to carry out the method. The method described below can be carried out using the configurations illustrated in FIGS. 1-3 and 5, for example, and various elements of these figures are referenced in explaining the embodiment. Each block shown in FIG. 4 represents one or more processes, methods, or subroutines carried out in the embodiment. Furthermore, the illustrated order of blocks is by example only, and the order of the blocks can be changed. Additional blocks can be added or fewer blocks can be utilized, without departing from this disclosure. The method can begin at block S501.

Blocks S501 and S502 are similar as described above regarding blocks S401 and S402, respectively.

At block S503, the determination module 1003 determines whether the location of the input signal is located within the area 141. If the location of the input signal is located outside of the area 141, block S504 is implemented. If the location of the input signal is located within the area 141, block S505 is implemented.

At block S504, the execution module 1004 responds to the touch event corresponding to the input signal, and the display module 1001 displays the fingerprint icon 15 according to the second method.

In one embodiment, the second method refers to the fingerprint icon 15 not covering the user interface 121. In one embodiment, the fingerprint icon 15 is displayed in another location (herein referred to as “the hidden area”) located outside of the area 141 and not covering the user interface 121. In another embodiment, the fingerprint icon 15 is displayed in the hidden location in a reduced size. In another embodiment, the fingerprint icon 15 is displayed translucently on the area 141 so that the fingerprint icon 15 does not cover the user interface 121.

The embodiment as shown in FIG. 5D, when a pressing touch is not applied within the area 141, such as pressing the number “2” on the user interface 121, the detection module 1002 uses the touch sensor 13 to detect the input signal and generate the touch event (pressing the number “2”). Since the location of the input signal is located outside of the area 141, the execution module 1004 responds to the touch event corresponding to the input signal. For example, the execution module 1004 can input the number “2” in a number input field 122 of the user interface 121. The display module 1001 simultaneously moves the fingerprint icon 14 from the area 141 to the hidden area (such as the lower right corner) and reduces a size of the fingerprint icon 15 by 10%.

At block S505, the determining module 1003 further determines whether the input signal is applied longer than a predetermined length of time (such as 2 seconds). For example, the input signal applied longer than the predetermined length of time indicates that the input signal is a pressing touch gesture. If the input signal is applied longer than the predetermined length of time, block S506 is implemented. If the input signal is applied less than the predetermined length of time, block S507 is implemented.

At block S506, the execution module 1004 responds to the fingerprint event corresponding to the input signal and does not respond to the touch event. In one embodiment, the display module 1001 displays the fingerprint icon according to the first method.

The embodiment as shown in FIG. 5C, the fingerprint icon 15 is overlapped with the number “8” of the user interface 121. When the area 141 is pressed where the fingerprint icon 15 is displayed for longer than the predetermined length of time, the detection module 1002 uses the touch sensor 13 to detect the input signal and generate the touch event (pressing the number “8”) and uses the fingerprint sensor 14 to detect the input signal and generate the fingerprint event. Because the input signal was applied within the area 141 for longer than the predetermined length of time, the execution module 1004 only responds to the fingerprint event corresponding to the input signal and does not respond to the touch event. In one embodiment, the execution module 1004 reads the fingerprint scanned by the fingerprint sensor 14 and determine whether the fingerprint matches the prestored fingerprint. When the fingerprint matches the prestored fingerprint, the display 12 displays another user interface.

At block S507, the execution module 1004 responds to the touch event and does not respond to the fingerprint event. In one embodiment, the display module 1001 displays the fingerprint icon 15 according to the second method.

The embodiment as shown in FIG. 5C, the fingerprint icon 15 is overlapped with the number “8” of the user interface 121. When the area 141 is pressed where the fingerprint icon 15 is displayed for less than or equal to the predetermined length of time, the detection module 1002 uses the touch sensor 13 to detect the input signal and generate the touch event (pressing the number “8”) and uses the fingerprint sensor 14 to detect the input signal and generate the fingerprint event. Because the input signal was applied within the area 141 for less than or equal to the predetermined length of time, the execution module 1004 responds to the touch event corresponding to the input signal and does not respond to the fingerprint event. In one embodiment, the execution module 1004 input the number “8” in a number input field 122 of the user interface 121.

In the first and the second embodiments of the method of FIGS. 3 and 4, when the display module 1001 moves the fingerprint icon 15 from the area 141 to the hidden area, no matter if the display module 1001 reduces the size of the fingerprint icon or if the fingerprint sensor 14 detects the input signal, the execution module 1004 does not respond to the fingerprint event. When the display module 1001 moves the fingerprint icon 15 from the area 141 to the hidden area, if the touch sensor 13 detects the input signal on the hidden area, the display module 1001 switches to the first method of displaying the fingerprint icon 15 (displaying the fingerprint icon 15 non-transparently on the area 141). Then, one of blocks S403, S503, and S505 is implemented again.

In another embodiment, the display module 1001 displays the fingerprint icon 15 according to the first method in blocks S401, S404, S501, and S506. The display module 1001 does not change the display method of the fingerprint icon 15 in blocks S405, S504, and S507. When the fingerprint icon 15 has been displayed according to the first method for a predetermined length of time (such as 3 or 4 seconds) and the touch sensor 13 does not detect an input signal within the area 141 of the fingerprint sensor 14, the display module 1001 switches to the second method of displaying the fingerprint icon 15.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A screen fingerprint enablement method implemented in an electronic device comprising a touch sensor and a fingerprint sensor, the method comprising:
displaying an user interface and a fingerprint icon simultaneously on a display of the electronic device, the fingerprint icon displayed in an area corresponding to the fingerprint sensor;
detecting an input signal on the display by using the touch sensor and generating a corresponding touch event;
detecting an input signal on the display by using the fingerprint sensor and generating a corresponding fingerprint event;
responding to the fingerprint event corresponding to the input signal when the input signal is applied within the area corresponding to the fingerprint sensor; and
responding to the touch event corresponding to the input signal when the input signal is not applied within the area corresponding to the fingerprint sensor.

2. The screen fingerprint enablement method of claim 1, wherein when the input signal is applied within the area corresponding to the fingerprint sensor for a length of time longer than a predetermined length of time:
the fingerprint event is responded to; and
the touch event is not responded to.

3. The screen fingerprint enablement method of claim 2, wherein when the input signal is applied within the area corresponding to the fingerprint sensor for a length of time less than or equal to the predetermined length of time:
the touch event is responded to; and
the fingerprint event is not responded to.

4. The screen fingerprint enablement method of claim 1 further comprising:
displaying a fingerprint icon according to a first method when the input signal is applied within the area corresponding to the fingerprint sensor; and
displaying the fingerprint icon according to a second method when the input signal is not applied within the area corresponding to the fingerprint sensor or when the fingerprint icon has displayed for a predetermined length of time; wherein:
the first method comprises:
displaying the fingerprint icon such that the fingerprint icon covers a portion of the user interface; and
the second method comprises:
displaying the fingerprint icon such that the fingerprint icon does not cover a portion of the user interface.

5. The screen fingerprint enablement method of claim 4, wherein:
the first method further comprises displaying the fingerprint icon non-transparently on the area corresponding to the fingerprint sensor; and
the second method further comprises displaying the fingerprint icon in a hidden area, or displaying the fingerprint icon in the hidden area in a smaller size, or displaying the fingerprint icon translucently on the area corresponding to the fingerprint sensor; wherein
the hidden area is an area outside of the area corresponding to the fingerprint sensor, and the hidden area does not cover or overlap with the user interface.

6. The screen fingerprint enablement method of claim 5 comprising:
not responding to the fingerprint event when the fingerprint icon is moved from the area corresponding to the fingerprint sensor to the hidden area; and
switching to the first method of displaying the fingerprint icon, when the fingerprint icon is moved from the area corresponding to the fingerprint sensor to the hidden area and when the touch sensor detects an input signal on the hidden area, and determining whether the fingerprint event is to be responded to according to the location of the input signal.

7. An electronic device comprising:
a touch sensor;
a fingerprint sensor;
a processor; and
a memory storing a plurality of instructions, which when executed by the processor, cause the processor to:
display an user interface and a fingerprint icon simultaneously on a display of the electronic device, the fingerprint icon displayed in an area corresponding to the fingerprint sensor;
detect an input signal on the display by using the touch sensor and generate a corresponding touch event;
detect an input signal on the display by using the fingerprint sensor and generate a corresponding fingerprint event;
respond to the fingerprint event corresponding to the input signal when the input signal is applied within the area corresponding to the fingerprint sensor; and
respond to the touch event corresponding to the input signal when the input signal is not applied within the area corresponding to the fingerprint sensor.

8. The electronic device of claim 7, wherein when the input signal is applied within the area corresponding to the fingerprint sensor for a length of time longer than a predetermined length of time:
the fingerprint event is responded to; and
the touch event is not responded to.

9. The electronic device of claim 8, wherein when the input signal is applied within the area corresponding to the fingerprint sensor for a length of time less than or equal to the predetermined length of time:
the touch event is responded to; and
the fingerprint event is not responded to.

10. The electronic device of claim 7, wherein the processor is further configured to:
display a fingerprint icon according to a first method when the input signal is applied within the area corresponding to the fingerprint sensor; and
display the fingerprint icon according to a second method when the input signal is not applied within the area corresponding to the fingerprint sensor or when the fingerprint icon has displayed for a predetermined length of time; wherein:
the first method comprises displaying the fingerprint icon such that the fingerprint icon covers a portion of the user interface; and
the second method comprises displaying the fingerprint icon such that the fingerprint icon does not cover a portion of the user interface.

11. The electronic device of claim 10, wherein:
the first method is displaying the fingerprint icon non-transparently on the area corresponding to the fingerprint sensor;
the second method is displaying the fingerprint icon in a hidden area, or displaying the fingerprint icon in the hidden area in a smaller size, or displaying the fingerprint icon translucently on the area corresponding to the fingerprint sensor; and
the hidden area refers to an area outside of the area corresponding to the fingerprint sensor and not covering or overlapping with a portion of the user interface.

12. The electronic device of claim 11, wherein the processor is further configured to:
not respond to the fingerprint event when the fingerprint icon is moved from the area corresponding to the fingerprint sensor to the hidden area; and
switch to the first method of displaying the fingerprint icon, when the fingerprint icon is moved from the area corresponding to the fingerprint sensor to the hidden area and when the touch sensor detects an input signal on the hidden area, and determine whether the fingerprint event is to be responded to according to the location of the input signal.

13. A non-transitory storage medium having stored thereon instructions that, when executed by at least one processor of an electronic device, causes the at least one processor to execute instructions of a screen fingerprint enablement method, the method comprising:
displaying an user interface and a fingerprint icon simultaneously on a display of the electronic device, the fingerprint icon displayed in an area corresponding to the fingerprint sensor;
detecting an input signal on the display by using the touch sensor and generating a corresponding touch event;
detecting an input signal on the display by using the fingerprint sensor and generating a corresponding fingerprint event;
responding to the fingerprint event corresponding to the input signal when the input signal is applied within the area corresponding to the fingerprint sensor; and
responding to the touch event corresponding to the input signal when the input signal is not applied within the area corresponding to the fingerprint sensor.

14. The non-transitory storage medium of claim 13, wherein when the input signal is applied within the area corresponding to the fingerprint sensor for a length of time longer than a predetermined length of time:
the fingerprint event is responded to; and
the touch event is not responded to.

15. The non-transitory storage medium of claim 14, wherein when the input signal is applied within the area corresponding to the fingerprint sensor for a length of time less than or equal to the predetermined length of time:
the touch event is responded to; and
the fingerprint event is not responded to.

16. The non-transitory storage medium of claim 13, wherein the method further comprises:
displaying a fingerprint icon according to a first method when the input signal is applied within the area corresponding to the fingerprint sensor; and
displaying the fingerprint icon according to a second method when the input signal is not applied within the area corresponding to the fingerprint sensor or when the fingerprint icon has displayed for a predetermined length of time; wherein:
the first method comprises displaying the fingerprint icon such that the fingerprint icon covers a portion of the user interface; and
the second method comprises displaying the fingerprint icon such that the fingerprint icon does not cover a portion of the user interface.

17. The non-transitory storage medium of claim 16, wherein:
the first method is displaying the fingerprint icon non-transparently on the area corresponding to the fingerprint sensor;
the second method is displaying the fingerprint icon in a hidden area, or displaying the fingerprint icon in the hidden area in a smaller size, or displaying the fingerprint icon translucently on the area corresponding to the fingerprint sensor; and
the hidden area refers to an area outside of the area corresponding to the fingerprint sensor and not covering or overlapping with a portion of the user interface.

18. The non-transitory storage medium of claim 17, wherein the method further comprises:
not responding to the fingerprint event when the fingerprint icon is moved from the area corresponding to the fingerprint sensor to the hidden area; and
switching to the first method of displaying the fingerprint icon, when the fingerprint icon is moved from the area corresponding to the fingerprint sensor to the hidden area and when the touch sensor detects an input signal on the hidden area, and determining whether the fingerprint event is to be responded to according to the location of the input signal.
